(19) United States
(12) Patent Application Publication
(10) Pub. No.: US 2014/0122377 A1
(43) Pub. Date: May 1, 2014

(54) SYSTEM AND METHOD FOR APPLYING A BUSINESS RULE MANAGEMENT SYSTEM TO A CUSTOMER RELATIONSHIP MANAGEMENT SYSTEM

(71) Applicant: InRule Technology, Inc., Chicago, IL (US)

(72) Inventors: Loren Goodman, Chesterfield, MO (US); Jeff Key, Chicago, IL (US); Rik Chomko, La Grange, IL (US); James Wray, Glenview, IL (US)

(73) Assignee: InRule Technology, Inc., Chicago, IL (US)

(21) Appl. No.: 13/663,144

(22) Filed: Oct. 29, 2012

(51) Int. Cl. G06N 5/02

(52) U.S. Cl. CPC G06N 5/025
USPC 706/11

(57) ABSTRACT

A system and a method for applying a business rule management system (“BRMS”) to a customer relationship management (“CRM”) system to create, test and/or publish a business rule in the CRM system is provided. A business rule editor utilizes template business rules constructed from domain-specific language and/or terminology and/or natural language and/or syntax. A business rule tester may test the business rule to ensure the business rule does not provide unintended results. A business rule publisher may publish the business rule into a production environment.

### BACKGROUND OF THE INVENTION

The present invention generally relates to a system and a method for applying a business rule management system (“BRMS”) to a customer relationship management (“CRM”) system to create, test and/or publish a business rule in the CRM system.

It is generally known, for example, that a business entity may use a CRM system to organize, automate and/or synchronize business processes. The CRM system involves a set of tools that deliver the capability of exposing various business related rules and business logic of applications to a non-technical audience. Further, the CRM system may allow a database, business rules and decision logic to be shared across multiple applications and/or platforms. As a result, the customer data, business rules and/or decision logic may be applied consistently across the divisions within the business entity. For example, the processing, sales and/or marketing divisions of the business entity have access to the same and the latest customer data, business rules and decision logic.

The CRM system may also collect data from and/or about customers and/or store the information within a database. The customer data may have personal, financial, health and/or medical information, such as, for example, names, addresses, social security numbers, age information, net income, medical histories, treatments and/or the like. The business entity may then utilize the CRM system to process the customer data and/or make a determination about the data by applying a business rule and/or decision logic to the customer data. The business rule or rules may be in the form of an algorithm or logic statement. Customer data may then be applied to the business rule to determine a value and/or an outcome. For example, a credit card issuer may utilize a CRM system to apply a business rule to financial information collected from a prospective applicant. As a result, the CRM system may output a result and/or determination regarding the creditworthiness of the customer. The business entity may decide whether to issue a credit card to the customer based on the output results of the applied business rule.

Market forces and/or a change in business procedures often require a business entity to modify existing and/or implement new business rules. Traditionally, the modifying existing business rules and/or the authoring of a new business rule required the staffing of CRM software programmers and/or the hiring of CRM software consultants. The staffing and/or hiring of CRM programmers and/or consultants may require time, effort and/or resources. Further, the CRM programmers and/or consultants may be unfamiliar with the strategy, business rules and/or decision logic of the business entity. As a result, nuances of complex business rules and/or concepts may be lost in translation throughout the business rules development process which further results in wasted time, effort and/or resources.

Therefore, a need exists for a system and a method for applying a BRMS to a CRM system to create, test and/or publish a business rule in the CRM system. Further, a need exists for a system and a method for applying a BRMS to a CRM system to create, test and/or publish a business rule in the CRM system without requiring the user to write program code. Additionally, a need exists for a system and a method for applying a BRMS to a CRM system to create a business rule within a graphical user interface (“GUI”) utilizing domain-specific language and/or terminology. And further, a need exists for a system and a method for applying a BRMS to a CRM system to create a business rule within a GUI utilizing natural language and/or syntax. Moreover, a need exists for a system and a method for applying a BRMS to a CRM system to create a business rule within a GUI utilizing template business rules. Still further, a need exists for a system and a method for applying a BRMS to a CRM system to test a business rule outside of the CRM system. Furthermore, a need exists for a system and a method for applying a BRMS to a CRM system to ensure the business rule does not provide unintended results. Yet further, a need exists for a system and a method for applying a BRMS to a CRM system to publish a business rule to a centrally-stored location accessible by the CRM system. Even further, a need exists for a system and a method for applying a BRMS to a CRM system to publish a business rule into a production environment.

### SUMMARY OF THE INVENTION

The present invention generally relates to a system and a method for applying a business rule management system (“ERNS”) to a customer relationship management (“CRM”) system to create, test and/or publish a business rule in the CRM system. The system and the method may allow a user to create, test and/or publish a business rule in the CRM system without writing program code. In addition, the system and the method may allow a user to create a business rule by utilizing template business rules constructed in domain-specific language and/or terminology and/or natural language and/or syntax. Further, the system may allow a user to input control data with known results into a business rule to verify the accuracy of the business rule. Also, the system may allow a user to publish the business rule into an environment, such as a production environment, for example. Similarly, the system may allow a user to modify, deploy and document changed made to an application. Further, for applications with complex, frequently changing business logic, the CRM delivers process agility by allowing users to update business decision logic as needed.

To this end, in an embodiment of the present invention, a system for the user to create a business rule wherein each business rule is composed of a template statement is disclosed. The system has a computer, a graphical user interface operatively associated with the computer and a rule editing system executed by the computer and controlled by the user interacting with the graphical user interface. The rule editing system allows the user to create the business rule or rules by assembling business rule templates, each business rule template being composed of predetermined business rule components. Also, the rule editing system allows the user to create the business rule or rules in a spreadsheet-like formula syntax. Further, the user may create complex nested conditions and aggregate functions in the spreadsheet-like formula syntax. With the rule editing system, the user may also manage logical data entity structures and their relationships and call web services from a rule application. The rule editing system system may allow the user to create and assign categories to elements such as fields and calculations and create and manage versions for processing by effective date. Finally, the user has complete flexibility and may use an expression builder within the rule management system to create new rule expressions.

In an embodiment, the system has the graphical user interface expressing the business rule in natural language.

In an embodiment, the system has natural language and/or syntax for creating a business rule.

In an embodiment, the system has the graphical user interface having at least one of a drop-down menu, type-ahead filtering and point-and-click selection.

In an embodiment, the system has a rule testing system executed by the computer wherein the user may interact with the graphical user interface to verify the accuracy of the business rule or rules within the rule testing system.

In an embodiment, the system has a rule publishing system executed by the computer wherein the user interacts with the graphical user interface to publish the business rule or rules from the rule publishing system and into a production environment.

In another embodiment, a method for creating a business rule for the processing of information is disclosed. The method provides a graphical user interface and applies a first plurality of template rule statements within the interface. Each template rule statement within the first plurality of template rule statements has a predetermined arrangement of business rule components. Further, the method may select at least one of the first plurality of template rule statements to create the business rule.

In an embodiment, the method applies a second plurality of template rule statements after the first plurality of template rule statements. Each template rule statement within the second plurality of template rule statements has a predetermined arrangement of business rule components. Further, the method may select at least one of the second plurality of template rule statements to create the business rule.

In an embodiment, the method provides the first plurality of template rule statements in natural language.

In an embodiment, the method displays the plurality of template rule statements within a drop-down menu.

In an embodiment, the method selects the plurality of template rule statements with type-ahead filtering.

In another embodiment, a method for creating a business rule for determining a business outcome with respect to business input data is disclosed. The business rule or rules express a business process for determining a business outcome. Next, the user inputs business input data to the business rule to allow the business rule to determine a business outcome. Further, the method provides a graphical user interface and allows the user to load control data to verify the accuracy of the business rule or rules wherein the control data has a known control output result or results. The user may then interact with the graphical user interface to compare the control results to business rule results derived from using real data.

In an embodiment, the method provides a message within the interface wherein the message notifies the user of an error in generating the test output result.

In an embodiment, the method allows the user to edit the business rule with respect to the control output result. Further, the method allows the user to reload the control data and reapply the control data to the business rule. Moreover, the method regenerates a control output result.

In an embodiment, the method generates time-stamp metadata information regarding the business rule and stores the time-stamp metadata information with the business rule.

In an embodiment, the method displays a comment field having comments regarding the business rule and stores the comments entered within the comments field with the business rule.

In an embodiment, the method displays a hierarchical file tree structure having a plurality of directories for storing and organizing the business rule and stores the business rule within one of the plurality of directories.

In an embodiment, the method allows the user to publish the business rule from the interface and into a production environment.

It is, therefore, an advantage of the present invention to provide a system and a method to create a business rule.

An additional advantage of the present invention is to provide a system and a method for the user to create a business rule without writing program code.

Another advantage of the present invention is to provide a system and a method for the user to create a business rule within a GUI utilizing template business rules.

And, another advantage of the present invention is to provide a system and a method for the user to create a business rule within a GUI utilizing domain-specific language and/or terminology.

Yet another advantage of the present invention is to provide a system and a method for the user to create a business rule within a GUI utilizing natural language and/or syntax.

A further advantage of the present invention is to provide a system and a method for the user to store, organize and/or catalog business rules within a GUI utilizing a folder tree.

Moreover, an advantage of the present invention is to provide a system and a method for the user to publish a business rule to a centrally-stored location accessible by the CRM system.

And, another advantage of the present invention is to provide a system and a method for the user to save a business rule within a GUI having a time-stamped date such that the user may distinguish between revisions and/or similar rules.

Yet another advantage of the present invention is to provide a system and a method for the user to test a business rule outside of the CRM system to ensure the business rule does not provide unintended results.

Another advantage of the present invention is to provide a system and a method to test a business rule by applying existing test data and/or production environment data to the business rule.

A still further advantage of the present invention is to provide a system and a method for the user to allow a user to test a business rule by comparing the output results of the new business rule to the output results of existing business rules.

Moreover, another advantage of the present invention is to provide a system and a method for the user to iteratively create a business rule by writing, testing, editing and/or retesting the business rule.

A still further advantage of the present invention is to provide a system and a method for the user to publish a business rule into an environment and define when the business rule will execute.

### BRIEF DESCRIPTION OF THE DRAWINGS

FIG. 1 is a black box illustrating a system allowing the user to apply a BRMS to a CRM system to create, test and/or publish a business rule in a CRM system as shown in an embodiment of the present invention.

FIG. 2 is a flowchart illustrating the BRMS in an embodiment of the present invention.

FIG. 3 is a screenshot of a graphical user interface in an embodiment of the present invention.

FIG. 4a is a screenshot of a graphical user interface in an embodiment of the present invention.

FIG. 4b is a screenshot of a graphical user interface in an embodiment of the present invention.

FIG. 5 is a screenshot of a graphical user interface in an embodiment of the present invention.

FIG. 6 is a screenshot of a graphical user interface in an embodiment of the present invention.

FIG. 7 is a screenshot of a graphical user interface in an embodiment of the present invention.

FIG. 8 is a screenshot of a graphical user interface in an embodiment of the present invention.

FIG. 9 is a screenshot of a graphical user interface in an embodiment of the present invention.

FIG. 10 is a screenshot of a graphical user interface in an embodiment of the present invention.

FIG. 11 is a screenshot of a graphical user interface in an embodiment of the present invention.

FIG. 12 is a screenshot of a graphical user interface in an embodiment of the present invention.

FIG. 13 is a screenshot of a graphical user interface in an embodiment of the present invention.

FIG. 14 is a screenshot of a graphical user interface in an embodiment of the present invention.

### DETAILED DESCRIPTION OF THE INVENTION

The present invention generally relates to a system and/or a method allowing a user to apply a business rule management system (“BRMS”) to a customer relationship management (“CRM”) system to create, test and/or publish a business rule in the CRM system. In addition, the system and/or the method may allow a user to create, test and/or publish a business rule in the CRM system without writing program code.

Referring now to the drawings wherein like numerals refer to like parts, FIG. 1 illustrates a black box diagram of the system 100 in an embodiment of the present invention. The system 100 may have a server 130, a storage database 140, a communications network 150, user terminals 160 and a customer terminal 170. The server 130 may be a computer system that runs an operating system such as, for example, Microsoft® Windows®, or Linux® and which may support a runtime environment, such as JAVA®, Flash® and/or the like. In addition, the server 130 may execute applications including a CRM system 120. Example of CRM system 120 include, but are not limited to Microsoft Dynamics CRM, mySAP Customer Relationship Management (CRM) system, and Oracle E-Business Suite CRM system and/or the like. The CRM system 120 may also have a rules-based decision-making engine. The server may operate a BRMS 110 which may have a Business Rule Editor (“BR Editor”) 132, a Business Rule Tester (“BR Tester”) 134 and/or a Business Rule Publisher (“BR Publisher”) 136.

The server 130 may communicate with the user terminals 160 and/or the customer terminal 170 via the communication network 150. The communications network 150 may be a Local Area Network (LAN), an intranet, an extranet and/or the Internet. The user terminals 160 and/or the customer terminal 170 may allow a customer and/or an employee to interact with the CRM system through the server 130. The user terminals 160 and/or the customer terminal 170 may be a machine in the form of a personal computer (PC), a tablet PC, a Personal Digital Assistant (PDA), a smart phone and/or the like. The user terminals 160 and the customer terminal 170 may have one or more user interface devices, such as, for example, a keyboard, a touch screen, a mouse, a trackball, a touch pad, a pen or the like, for interacting with a graphical user interface (GUI) that may be provided by a display and/or a monitor.

The customer terminal 170 may have a machine used by a current customer or a prospective customer, such as, for example, an applicant for a credit card or an applicant for insurance coverage and/or the like. A customer may use a browser application, such as, for example, Microsoft Internet Explorer or Mozilla Firefox, on a computer system to communicate with the server 130. The customer terminal 170 may allow the customer to input and/or submit customer data into the CRM system 120 through the server 130. The customer data may be representative of various industries. For example, customer data in the healthcare industry may include health plan underwriting, eligibility determination and enrollment, HMO product customization and pricing, case management, population management, pre-service medical necessity validation, prior authorization, benefit authorization, and cost estimation, claims scrubbing, verification and processing, regulated reporting and analysis, clinical rule processing and bill reporting. Customer data may also include personal, financial, health and/or medical information, names, addresses, social security numbers, age information, income, medical histories, treatments and/or the like. Next, customer data in the insurance industry may include rating information, automated underwriting, claims routing and management, suitability and/or compliance, policy management and document management information. Customer data in the banking and financial services industry may include credit scoring and risk assessment, loan origination, pro-forma trading models, fraud detection, wealth management, invoice management, revenue management and appraisal processing. Next, customer data in business process management may include business activity monitoring interoperability, work flow integration and dynamic decision making and enterprise service bus rule processing. Customer data in government and government-related services may include benefits eligibility, budgeting, tax and/or fee calculations and eForms initiatives. Also, customer data may be supplied across several industries and include supply chain management and monitoring, product configuration, systems diagnostics, quota processing, regulation compliance and monitoring, job costing, revenue recognition and reporting, commissions, pricing, and billing self-service and service automation. Customer data is not limited to the situations and examples identified above and may extend to other like situations and examples. The customer data may be transmitted to the server 130 via the network 150.

The user terminals 160 may have a machine used by an employee and/or a user of the business entity, such as, for example, those within a sales division, a marketing division, an analytics division and/or the like. The user may utilize the CRM system 120 via a machine operating Windows®, or Linux®. In addition, the user may interact with the CRM system 120 and the BRMS 110 through the user terminals 160. The user may utilize a BR Editor 132 to create and/or to modify algorithms and/or business rule logic and/or may access market data, historical pricing information, current pricing information, customer information, contact information and/or the like. Further, the user may utilize the BR Tester 134 to test a newly created business rule. Moreover, the user may utilize the BR Publisher 136 to publish a newly created business rule into an environment, such as, for example, a production environment.

The server 130 may be in communication with the storage database 140 to store data and/or to retrieve data from the storage database 140. The storage database 140 may store and/or retrieve systems data related to operations impacted by the CRM system 120 and the BRMS 110. Further, the storage database 140 may store customer data and/or business rule information relied upon by the CRM system 120 and the BRMS 110 such as customer information, contact information, algorithms and/or business rule logic, proprietary business entity information and/or the like.

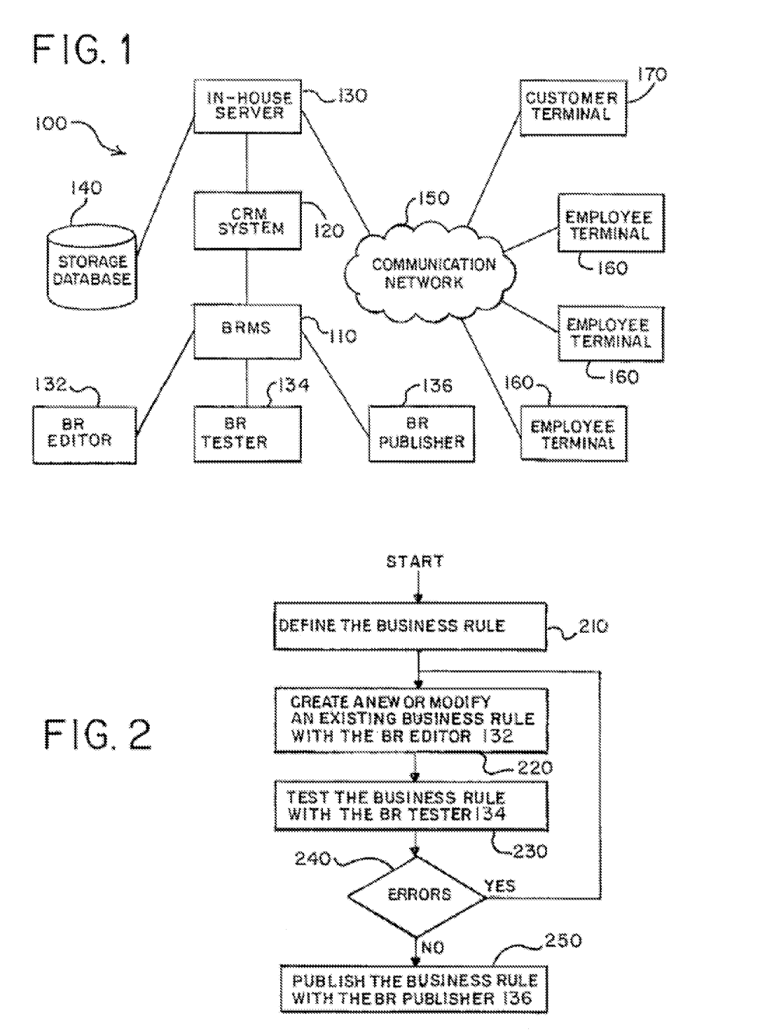

FIG. 2 illustrates a flowchart showing the steps of a method for applying a BRMS 110 to the CRM system 120 to create a business rule in an embodiment of the invention. The flowchart is described with reference to the black box diagram and components of FIG. 1. As generally shown at step 210, a user may define a business rule. As generally shown at step 220, the user may utilize the user terminals 160 to create a new rule within the BR Editor 132. The user may create the new rule by modifying an existing rule and/or creating a new rule. The user may consider the similarity of the new rule to the existing rule in determining whether to modify the existing rule.

As shown at step 230, the user may test the new rule using the BR Tester 134. The user may input previously saved customer data and/or test data to test the new rule. Further, the user may verify the accuracy of the new rule by comparing the output results of the new rule against the output results of an existing rule. If errors are detected in the output results of the new rule, the user may return to the BR Editor 132 to modify the new rule as shown at step 240. After the new rule has been edited, the user may again retest the new rule with the BR Tester 134. The iterative process of writing, testing, editing and/or retesting of a new rule may enable the user to verify that the new rule does not conflict with the existing rule and/or output unintended results.

As shown at step 250, the user may publish the new rule into a production environment using the BR Publisher 136 after the user has tested the new rule with the BR Tester 134. The new rule may be utilized by the CRM system 120 after the new rule has been published into the production environment. A user acting on behalf of a business entity may apply the new rule through the CRM system 120 to process customer data and/or make a determination about the customer data, such as, for example, whether a medical procedure may be covered or whether a credit card application may be accepted.

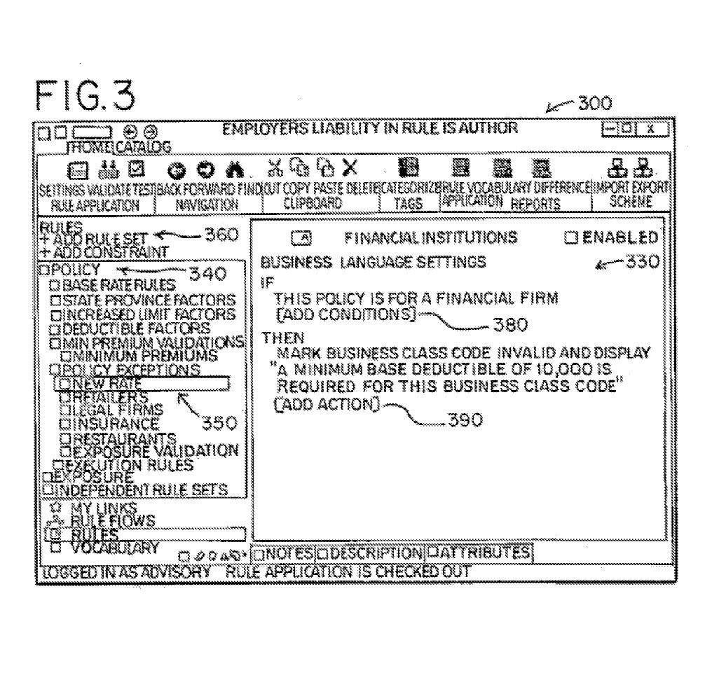

FIGS. 3, 4a, 4b, 5-10 generally illustrate screenshots of a graphical user interface (“GUI”) showing a rule authoring page 300 within the BR Editor 132. As illustrated in FIG. 3, the rule authoring page 300 may have a rule folder tree 310, a name field 320 and/or a language editor field 330. The screenshots of the rule authoring page 300 are described with reference to the flowchart of FIG. 2.

The rule folder tree 310 may allow the user to store a business rule to a central location accessible by the CRM system 120. In addition, the central location of the rule folder tree 310 may allow the user to organize and/or to access existing rules. The rules may be organized within the folder tree 310 such that similar rules and/or related rules may be stored within a common folder.

As illustrated in FIG. 3, the user may point-and--click on a target folder 340 to cause a rule within the target folder 340 to be displayed. The user may select a desired rule 350 within the target folder 340. Selecting the desired rule 350 may cause the desired rule 350 to load within the language editor field 330. The name of the desired rule 350 may be shown within the name field 320. Further, the rule language of the desired rule 350 may load within the language editor field 330 so that the user may modify the rule language as desired. The rule language may include, for example, an if/then statement requiring the existence of a particular medical condition before providing full medical coverage. Alternatively, the rule language, for example, may include an if/then statement requiring the existence of a minimum credit score prior to authorizing preliminary loan approval.

The language editor field 330 may allow the user to add new rule language to a new rule or an existing rule. In addition, the language editor field 330 may allow the user to modify the rule language of an existing rule. As illustrated in FIG. 3, the rule language of the desired rule 350 may be displayed in the language editor field 330. The user may add language to the desired rule 350 by selecting “[add condition]” 380 and/or “[add action]” 390. Selecting “[add condition]” 380 may allow the user to add conditional rule language, such as, for example, rule language requiring the existence of a particular precondition such as a medical condition or credit rating. Selecting “[add action]” 390 may allow the user to add operational rule language, such as, for example, rule language providing for full, partial or no medical coverage.

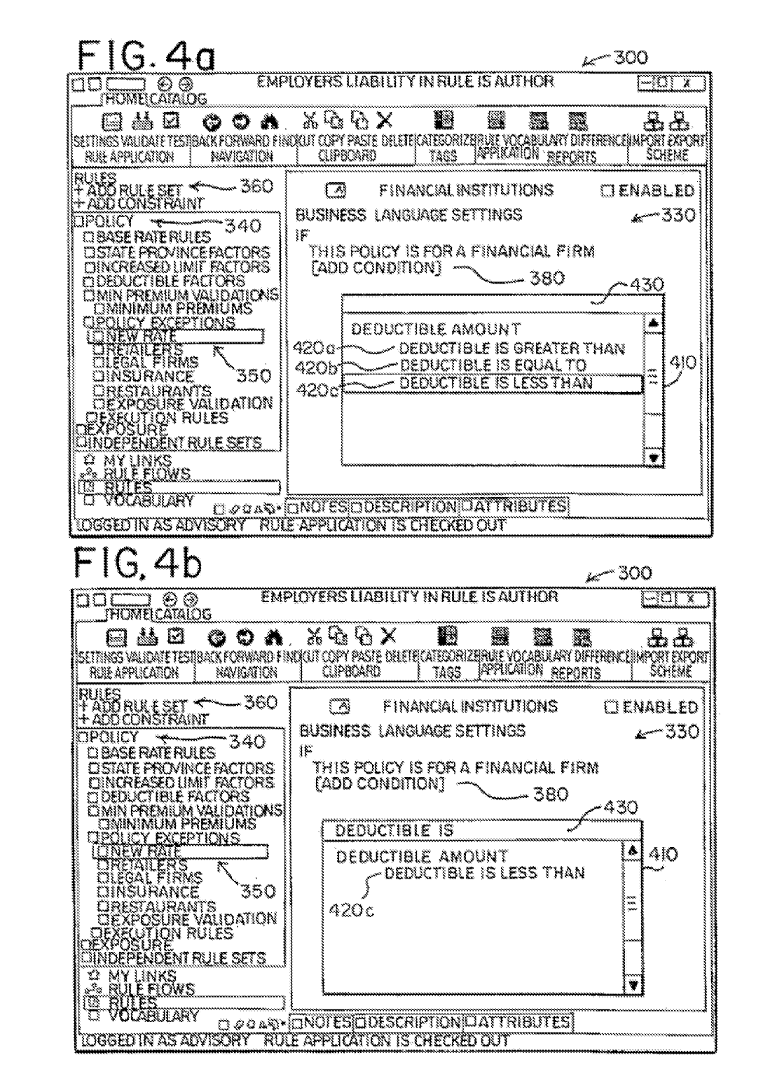

As illustrated in FIG. 4a, selecting “[add condition]” 380 and/or “[add action]” 390 may display a drop-down menu 410 wherein the user may select between template rules 420a-420c. The template rules 420a-420c may have industry-specific terminology and/or logic expressions that may be dedicated to a particular industry and/or solution technique of the business entity, such as, for example, terminology specific to medical treatments and expressions specific to patient coverage plans. The user may point-and-click on the drop-down menu 410 to select the desired template rule 420c. Alternatively, the user may enter text within the text field 430 of the drop-down menu 410. In addition, type-ahead filtering may be used to narrow the selection of the template rules 420a-420c. As illustrated in FIG. 4b, adding the text “Deductible is 1” within the text field 430 may narrow the selection of the template rules 420a-420c to template rule 420c. The user may then point-and-click to select the desired template rule 420c. As illustrated in FIG. 5, selecting template rules 420c may cause the rule language of the selected template rule 420c to be added to the existing rule language of the desired rule 350 and display within the language editor field 330.

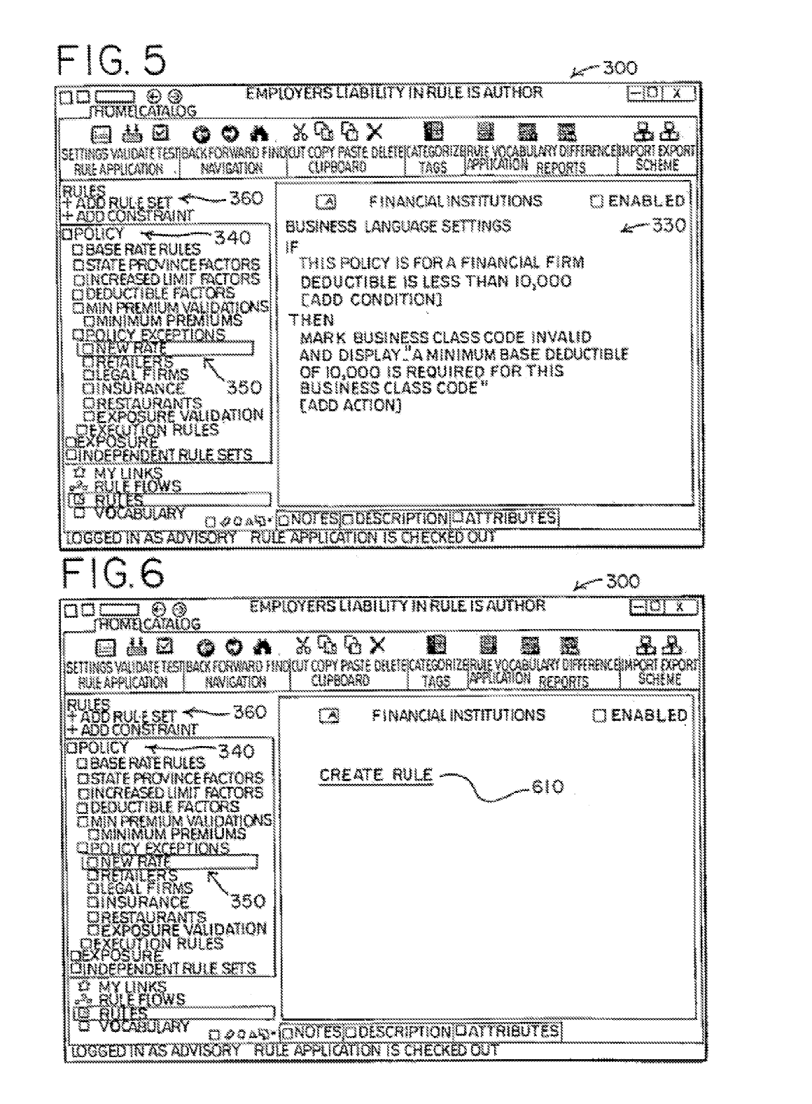

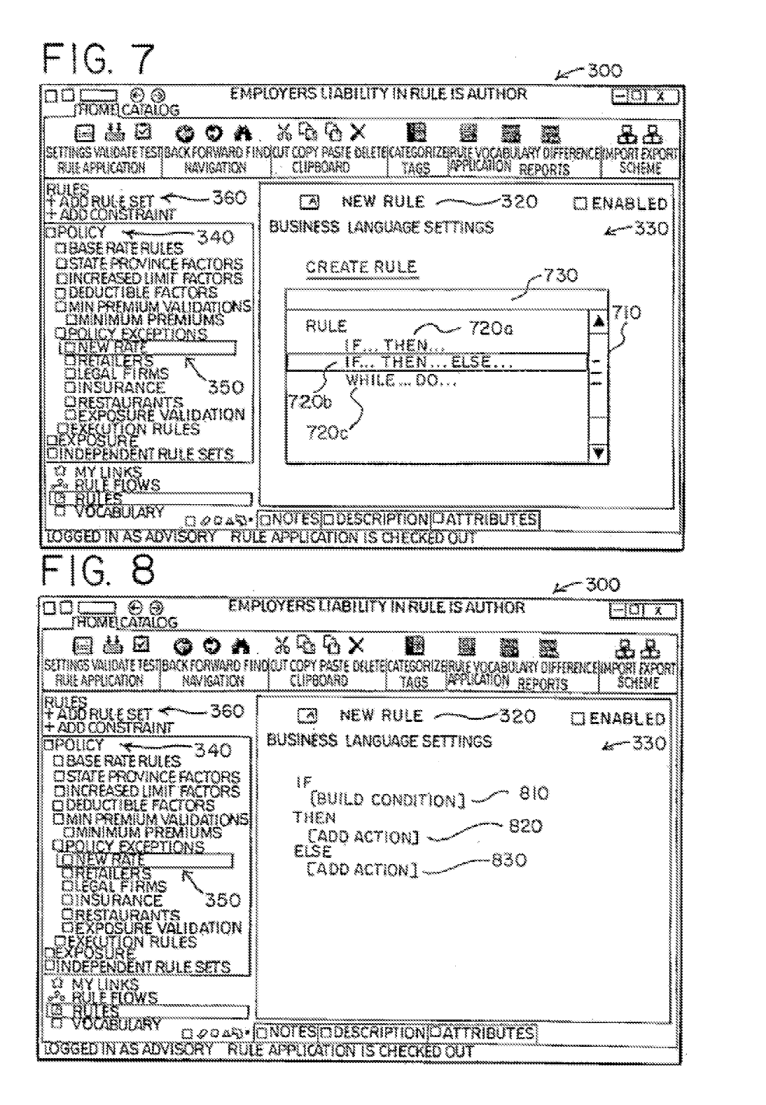

In another embodiment, the user may create a new rule by selecting the “Add Rule Set” button 360 as illustrated in FIG. 6. The user may enter a new rule name within the name field 320 and may save the new rule within any folder inside the folder tree 310. As shown in FIG. 6, the user may begin constructing a new rule within the language editor field 330 by selecting “Create Rule” 610. As illustrated in FIG. 7, selecting “Create Rule” 610 may display a drop-down menu 710, and the user may select between template rules 720a-720c. The template rules 720a-720c may have logic expressions such as, for example, an If . . . Then . . . statement, an If . . . Then . . . Else . . . statement and a While . . . Do . . . statement. The user may point-and-click within the drop-down menu 710 to select the desired template rule 720b. Further, the drop-down menu 710 may provide a text input field 730. Type-ahead filtering may be used to narrow the selection of the template rules 720a-720c. As illustrated in FIG. 8, selecting template rule 720b may cause the rule language of the selected template rule 720b to be added to the new rule and displayed within the language editor field 330.

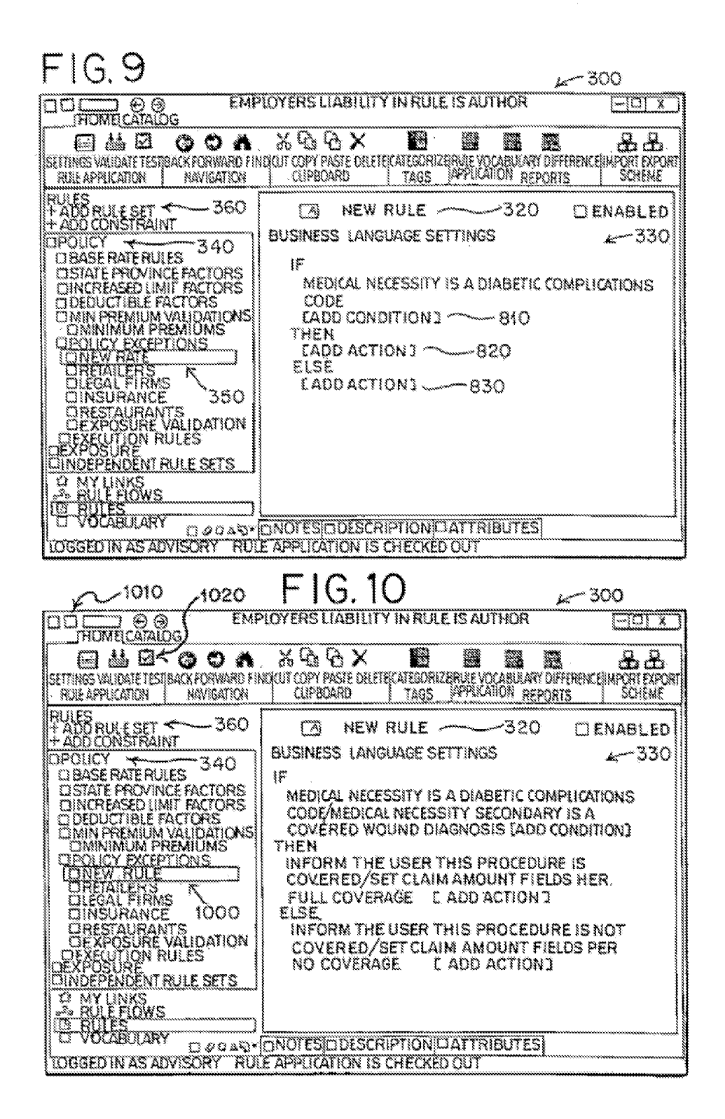

As illustrated in FIGS. 8 and 9, the user may add additional rule language within the selected template rule 720b by selecting “[add condition]” 810 and/or “[add action]” 820, 830. The user may continue to build the new rule by adding multiple conditions and/or actions until the new rule is completed as illustrated in FIG. 10. After completion, the user may save the new rule by selecting the [save] button 1010. The new rule may be saved with a time-stamp. The user may distinguish between revisions and/or similar rules. The new rule may be reflected as a New Rule 1000 and may be displayed with the rule folder tree 310 of the rule authoring page 300. After saving the new rule, the user may select the [“Test”] button 1020 to access the BR Tester 134.

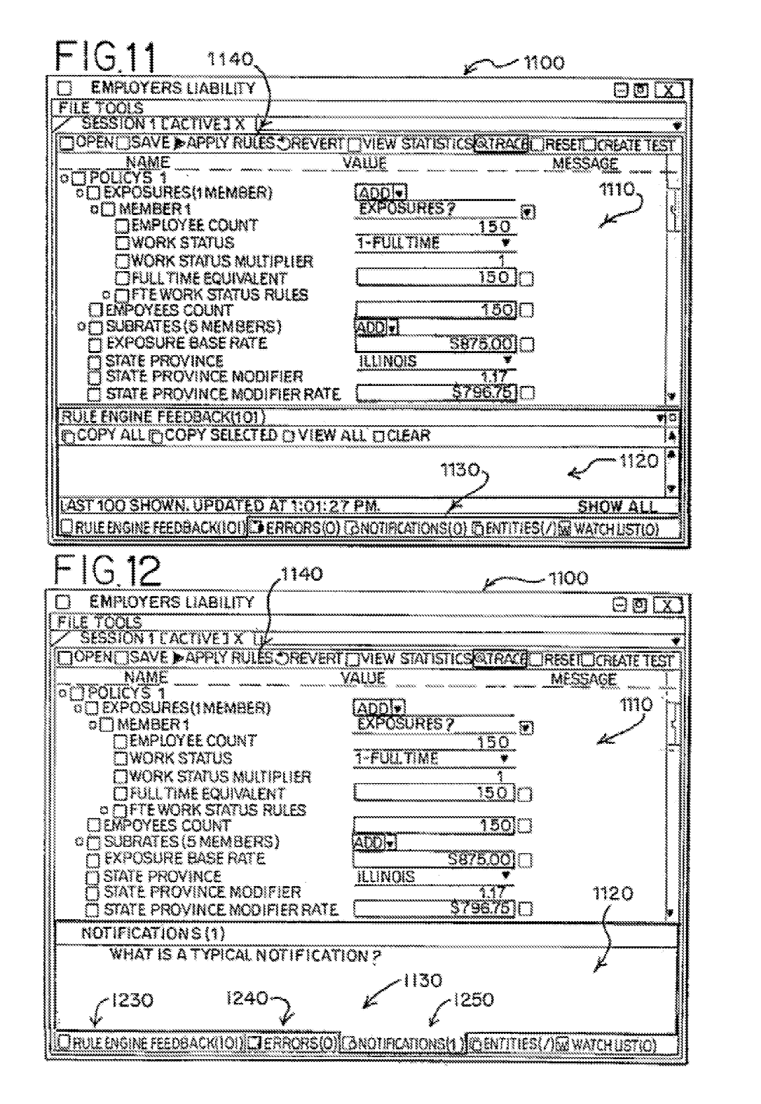

FIGS. 11 and 12 generally illustrate screenshots of a GUI showing a rule testing page 1100 within the BR Tester 134. As illustrated in FIG. 11, the rule testing page 1100 may have a test data window 1110, a results window 1120, a tabbed document interface 1130 and an [“Apply Rules”] button 1140. The screenshots of the rule testing page 1100 are described with reference to the flowchart of FIG. 2.

The user may test the new rule within the rule testing page 1100 of the BR Tester 134. The BR Tester 134 may allow the user to verify the accuracy of the rule by determining whether the new rule yields unintended results and/or violates an existing rule. The user may perform a regression test wherein the new rule may be tested against previously run tests. The user may load existing test data and/or production environment data into the rule testing page 1100. In addition, the user may individually enter testing values within the test data window 1110 as shown in FIG. 11. After loading and/or entering the existing test data, the user may select the [“Apply Rules”] button 1140 to apply the existing test data to the new rule.

As illustrated in FIG. 12, the rule testing page 1100 of the BR Editor 134 may display the test results of the new rule under the individual tabs of the tabbed document interface 1130. The “Rule Engine Feedback” tab 1230 may reflect information regarding field updates, rule execution order, rule execution time, rule sets applied and the the rules fired. The “Errors” tab 1240 may reflect errors occurring during the execution of the rule application, such as, for example, a run time error or an infinite loop error. Depending on the type of error, the user may navigate to the element in the rule application causing the error by “double-clicking” on the error listed in the “Errors” tab 1240. The “Notifications” tab 1250 may reflect the output results of the new rule with respect to the loaded test data. The user may examine the output results within the “Notifications” tab 1250 to ensure that the new rule may yield an expected result. If the output results yield inconsistencies and/or errors, the user may revert to the rule authoring page 300 of the BR Editor 132 to edit the rule. After editing, the user may return to the rule testing page 1100 of the BR Editor 134 and may retest the rule. The user may iteratively edit, test and/or retest the new rule until the user is satisfied by the output results. After the new rule is deemed acceptable by the user, the new rule may again be saved by selecting the [Save] button 1010 within the rule authoring page 300 of the BR Editor 132.

As illustrated in FIG. 13, the user may access the BR Publisher 136. The user may promote the new rule into the production environment. The user may access the BR Publisher 136 by right-clicking on the New Rule 1000 within the rule folder tree 310 of the rule authoring page 300. Right-clicking on the New Rule 1000 may display a pop-up menu 1300 from which the user may select Promote 1310 to access the BR Publisher 136.

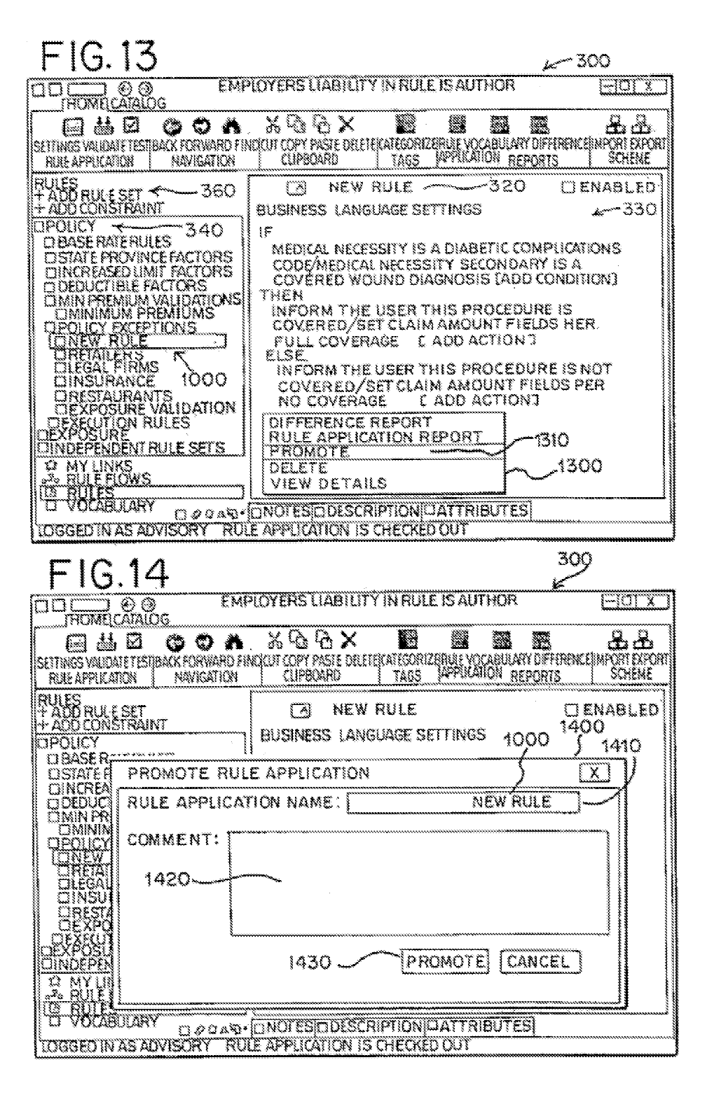

As illustrated in FIG. 14, a rule publisher page 1400 within the BR Publisher 136 may be displayed upon selecting

Promote 1310 within the pop-up menu 1300. The rule publisher page 1400 may have a name field 1410, a comment window 1420, and a Promote button 1430. The New Rule 1000 may be displayed within the name field 1410. In addition, the user may input any comments regarding the New Rule 1000 within the comment window 1420.

The user may select the Promote button 1430 to publish the New Rule 1000 from the BMRS 130 into the CRM System 120 and into the production environment. After publishing to the production environment, the New Rule 1000 may be utilized by the business entity and/or maybe applied to customer data. The new rule may be used to process the customer data and/or make a determination about the customer data, such as whether a medical procedure may be covered or whether a credit card application may be accepted.

In an alternative embodiment, the BRMS 110 may allow the user to specify when the new rule may execute. The user may designate the occurrence of an event or specified conditions after which the business rule may execute. The user may specify that the new rule may execute only after the satisfaction of a user specified precondition. For example, the user may specify that the new rule may only execute after the submission of a medical insurance claim for a patient having a preexisting medical condition.

The present invention should not be deemed as limited to the embodiments of text filtering and/or search tools. It should be understood that the language editor field 330 may have filtering tools and/or search tools, such as, for example, autocomplete, search as you type, filter/find as you type (FAYT), incremental search, inline search, instant search, word wheeling, and/or the like.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for creating a business rule indicative of business decision-logic based on user input, the system comprising:
a computer;
a graphical user interface operatively associated with the computer wherein the graphical user interface allows a user to input information;
a rule editing system executed by the computer and controlled by the user via the graphical user interface wherein the user interacts with the rule editing system to create business rules by either assembling template rule statements having predetermined business rule components or by authoring business rule statements.

2. The system of claim 1 further comprising:
pre-set template rule statements having the predetermined business rule components wherein the user may select from the template rule statements to define business rules in the rule editing system.

3. The system of claim 1 wherein the graphical user interface expresses the business rule in natural language.

4. The system of claim 1 wherein the graphical user interface has a drop-down menu with type-ahead filtering and point-and-click selection.

5. The system of claim 1 wherein the graphical user interface has a hierarchical file tree structure having a plurality of directories wherein the business rule is stored and organized within the plurality of directories.

6. The system of claim 1 further comprising:
a rule testing system executed by the computer wherein the user may test business rules within the rule testing system via the graphical user interface.

7. The system of claim 1 further comprising:
a rule publishing system executed by the computer wherein the graphical user interface publishes the business rule from the rule publishing system and into a production environment.

8. A method for implementing a business rule for the processing of information, the method comprising:
providing a graphical user interface operatively associated with a computer;
selecting at least one of a first plurality of template rule statements wherein each template rule statement has a predetermined arrangement of business rule components;
arranging the first plurality of template rule statements to produce a business rule;
executing the business rule or rules to process information.

9. The method of claim 8 further comprising
selecting at least one of a second plurality of template rule statements wherein each of the second plurality of template rule statements has a predetermined arrangement of business rule components to create the business rule; and
executing the second plurality of template rule statements after the first plurality of template rule statements.

10. The method of claim 8 further comprising providing the plurality of template rule statements in natural language.

11. The method of claim 8 further comprising displaying the plurality of template rule statements within a drop-down menu.

12. The method of claim 8 further comprising selecting the plurality of template rule statements with type-ahead filtering.

13. A method for verifying a business rule for determining a business outcome with respect to data input by a user wherein the business rule or rules express a business process for determining the business outcome , the method comprising:
providing a graphical user interface operatively associated with a computer;
loading control data to verify the accuracy of the business rule wherein the control data has a known control output result;
applying the control data to the business rule;
executing the business rule to generate a control output result; and
providing the control output result within the graphical user interface.

14. The method of claim 13 further comprising:
comparing a business rule output result to the control output result.

15. The method of claim 13 further comprising the step of:
providing a message within the graphical user interface wherein the message notifies of an error in generating the test output result.

16. The method of claim 13 further comprising the steps of:
editing the business rule with respect to the test output result;
reloading the control data;
reapplying the control data to the business rule; and
regenerating a control output result.

17. The method of claim 13 further comprising the step of:
generating time-stamp metadata information regarding the business rule; and
storing the time-stamp metadata information with the business rule.

18. The method of claim 13 further comprising the step of:
displaying a comment field having comments regarding the business rule;
storing the comments entered within the comments field with the business rule.

19. The method of claim 13 further comprising the step of:
displaying a hierarchical file tree structure having a plurality of directories for storing and organizing the business rule; and
storing the business rule within one of the plurality of directories.

20. The method of claim 13 further comprising the step of:
publishing the business rule from the graphical user interface and into a production environment.
